(19) United States
(12) Patent Application Publication
(10) Pub. No.: US 2025/0210055 A1
(43) Pub. Date: Jun. 26, 2025

(54) APPARATUS, METHODS AND COMPUTER PROGRAMS FOR NOISE SUPPRESSION

(71) Applicant: NOKIA TECHNOLOGIES OY, Espoo (FI)

(72) Inventors: Paschalis TSIAFLAKIS, Heist-op-den-Berg (BE); Mikko Tapio TAMMI, Tampere (FI); Konstantinos DROSOS, Helsinki (FI)

(21) Appl. No.: 18/990,653

(22) Filed: Dec. 20, 2024

(30) Foreign Application Priority Data
Dec. 22, 2023 (GB) 2319935.9

(51) Int. Cl. G10L 21/0208; G10L 21/0216

(52) U.S. Cl. CPC G10L 21/0208; G10L 2021/02166

(57) ABSTRACT

Examples of the disclosure relate noise suppression for audio signals in a communication setting. An apparatus obtains at least one audio signal for a current frame or one or more previous frames, based on at least two microphone signals for the current frame or one or more previous frames. The apparatus uses a program code to predict an output signal for a future frame based, at least in part, on the at least one audio signal for the current frame or one or more previous frames and uses the output signal for processing the future frame of the at least two microphone signals in a first audio signal process and uses the output signal for processing the future frame of an output of the first audio signal process in a second audio signal process to enable noise suppression.

### CROSS REFERENCE TO RELATED APPLICATIONS

This application claims priority to Great Britain Application No. 2319935.9, filed Dec. 22, 2023, the entirety of which is hereby incorporated by reference.

### TECHNOLOGICAL FIELD

Examples of the disclosure relate to apparatus, methods and computer programs for noise suppression. Some relate to apparatus, methods and computer programs for noise suppression for audio signals in a communication setting.

### BACKGROUND

Noise suppression for audio signals can be used in communication settings to improve the intelligibility of speech and/or other desired sounds. Program code such as machine learning programs can be used to implement the noise suppression.

### BRIEF SUMMARY

According to various, but not necessarily all, examples of the disclosure there is provided an apparatus for noise suppression comprising means for:
obtaining at least one audio signal for a current frame or one or more previous frames, based on at least two microphone signals for the current frame or one or more previous frames;
using a program code to predict an output signal for a future frame based, at least in part, on the at least one audio signal for the current frame or one or more previous frames; and
using the output signal for processing the future frame of the at least two microphone signals in a first audio signal process and using the output signal for processing the future frame of an output of the first audio signal process in a second audio signal process to enable noise suppression.

At least one audio signal may comprise an output of the first audio signal process.

The first audio signal process and the second audio signal process may be consecutive processes in which the output of the first audio signal process is provided as an input to the second audio signal process.

The first audio signal process may comprise a beamforming process, and wherein the beamforming process comprises processing the future frame of the at least two microphone signals using the output signal.

The output signal may comprise a gain to be applied to at least one of the at least two microphone signals of the beamforming process.

The output signal may comprise an amplitude to be used for at least one of the at least two microphone signals of the beamforming process.

The second audio signal process may comprise a spectral noise suppression process.

The output signal may comprise a gain to be applied to the input of the spectral noise suppression process.

The output signal may comprise an amplitude to be used for the spectral noise suppression process.

The output signal may be applied to the future frame of the respective audio signal processes in a frequency domain.

The program code may receive a single input and provides a single output.

The program code may comprise a machine learning program.

The machine learning program may comprise a neural network circuit.

The same output signal may be applied to future frames of multiple audio signal processes.

The number of current or previous frames in the obtained audio signal that are used to predict the output signal for a future frame may be selected based, at least in part, on latency requirements.

The apparatus may be for use in an audio communication setting.

The audio communication setting may be at least one of;
a one-way communication setting; or
a two-way communication setting.

According to various, but not necessarily all, examples of the disclosure there is provided an electronic device comprising an apparatus as described herein wherein the electronic device is at least one of: a telephone, a camera, a computing device, a teleconferencing device, a television, a virtual reality device, an augmented reality device.

According to various, but not necessarily all, examples of the disclosure there is provided a method comprising:
obtaining at least one audio signal for a current frame or one or more previous frames, based on at least two microphone signals for the current frame or one or more previous frames;
using a program code to predict an output signal for a future frame based, at least in part, on the at least one audio signal for the current frame or one or more previous frames; and
using the output signal for processing the future frame of the at least two microphone signals in a first audio signal process and using the output signal for processing the future frame of an output of the first audio signal process in a second audio signal process to enable noise suppression.

According to various, but not necessarily all, examples of the disclosure there is provided a computer program comprising instructions which, when executed by an apparatus, cause the apparatus to perform at least:
obtaining at least one audio signal for a current frame or one or more previous frames, based on at least two microphone signals for the current frame or one or more previous frames;
using a program code to predict an output signal for a future frame based, at least in part, on the at least one audio signal for the current frame or one or more previous frames; and
using the output signal for processing the future frame of the at least two microphone signals in a first audio signal process and using the output signal for processing the future frame of an output of the first audio signal process in a second audio signal process to enable noise suppression.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

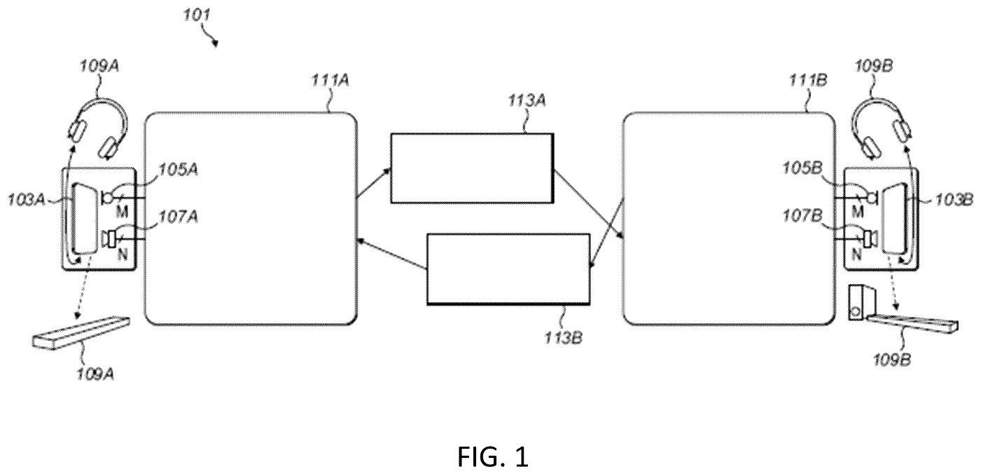

FIG. 1 shows an example system;

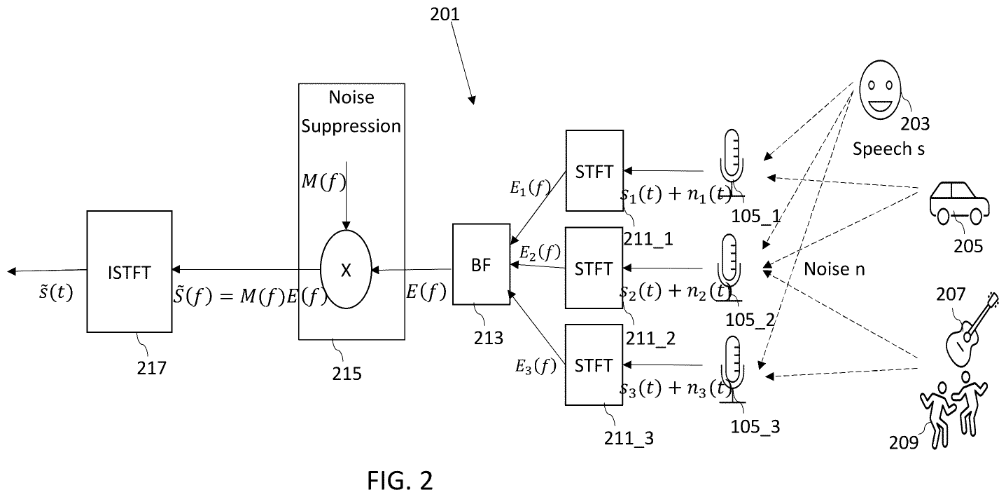

FIG. 2 shows an example of multi-channel noise suppression;

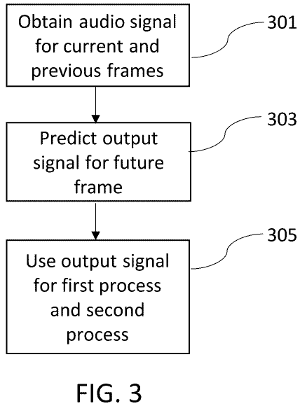

FIG. 3 shows an example method;

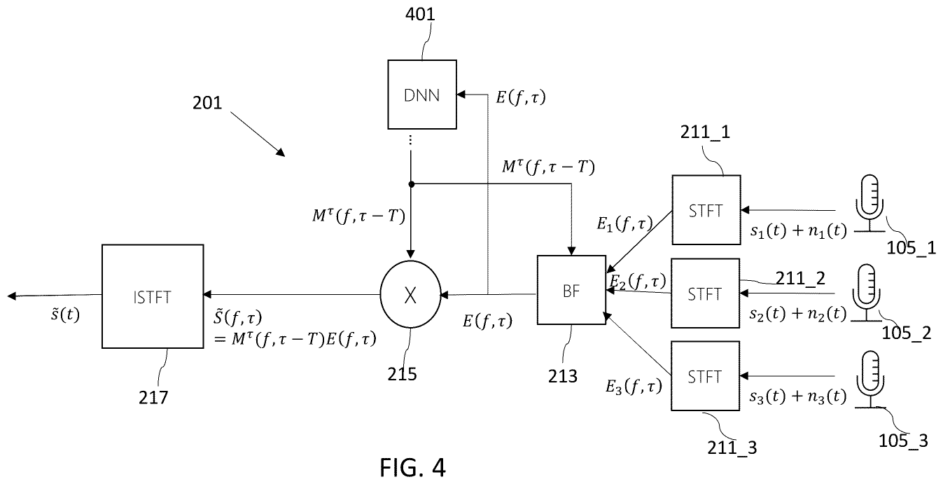

FIG. 4 shows an implementation of examples of the disclosure;

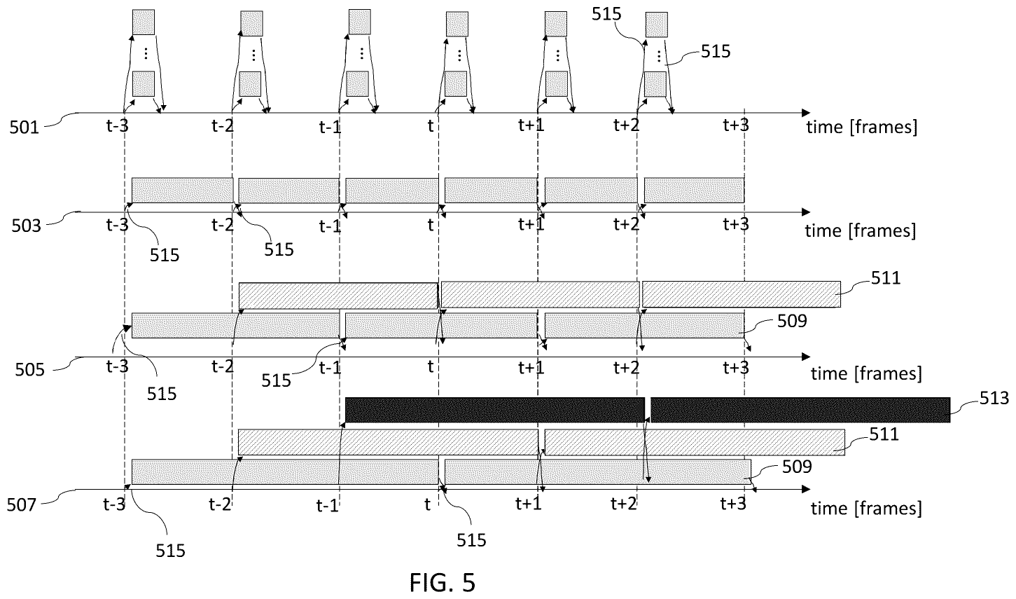

FIG. 5 shows an example computation pipeline;

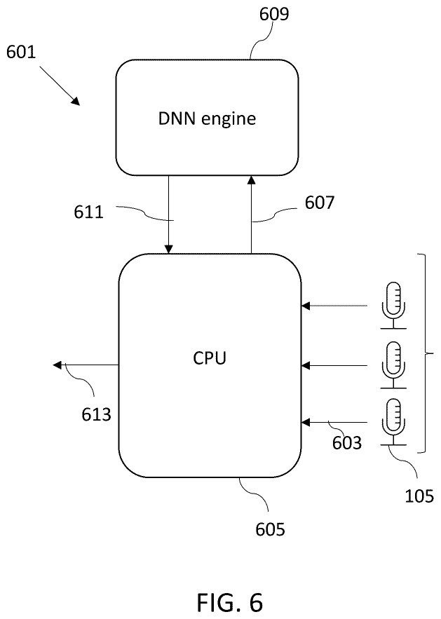

FIG. 6 shows an example system;

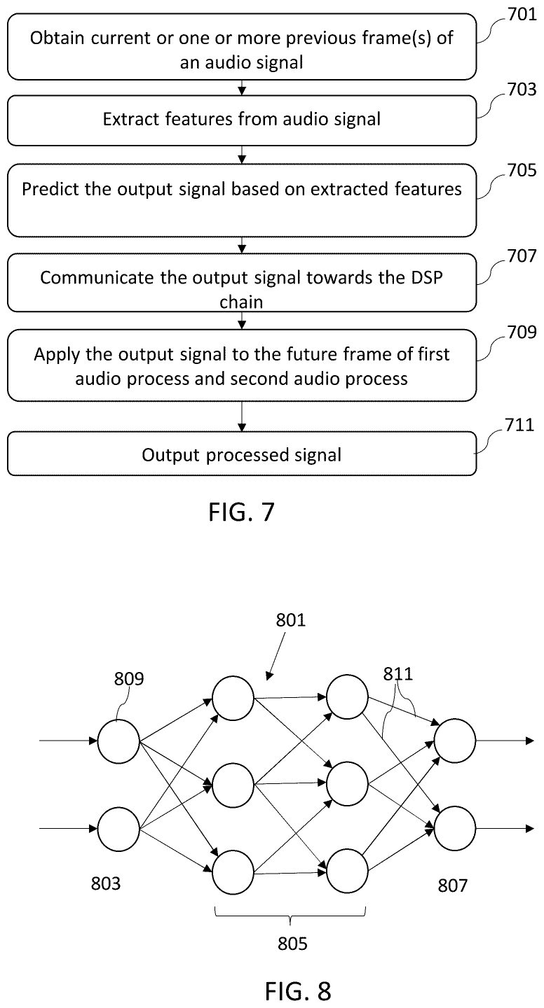

FIG. 7 shows an example method;

FIG. 8 shows an example machine learning program;

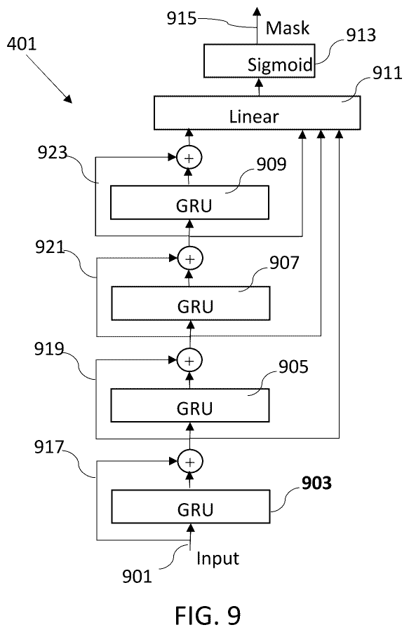

FIG. 9 shows an example architecture for a machine learning program;

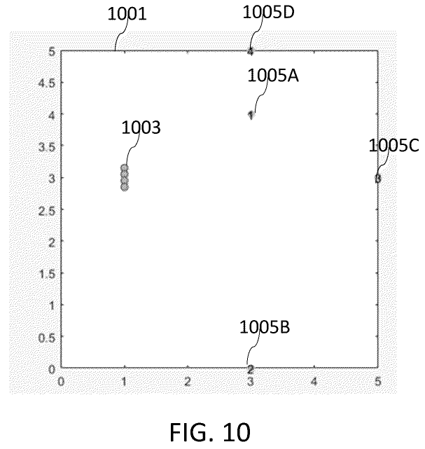

FIG. 10 shows an example room and microphone array;

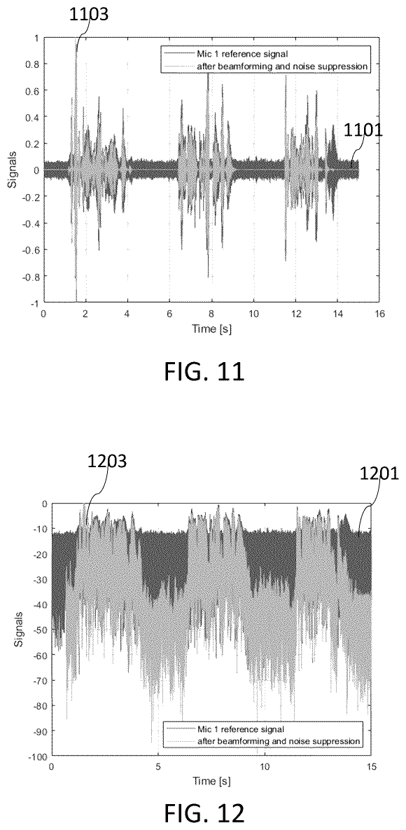

FIG. 11 shows a plot of example results;

FIG. 12 shows a plot of example results; and

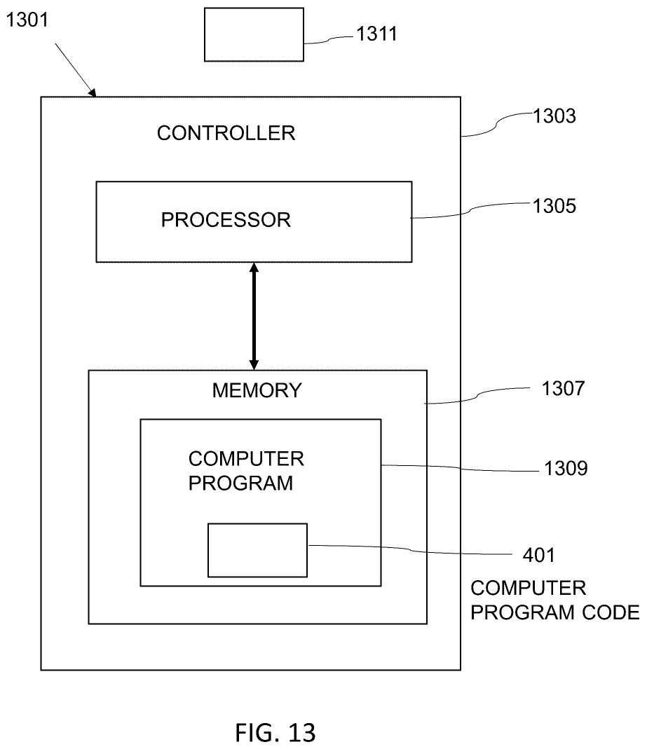

FIG. 13 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

Noise suppression for audio signals can be used in communication settings to improve the intelligibility and/or quality of speech and/or other desired sounds. Speech intelligibility reflects how well the content of the speech can be understood. Speech quality is used to describe how comfortable it is for someone to listen to the speech. Communication settings can require simultaneous capture and playback of audio signals which can be challenging for performing noise suppression. Program code such as machine learning programs can be used to implement the noise suppression.

Examples of the disclosure provide for improved noise suppression. The examples of the disclosure can be used in communication settings that use simultaneous capture and playback of audio signals and/or any other suitable settings. Examples of the disclosure enable a program code with low complexity and relaxed latency requirements to be used to implement the noise suppression and/or any other suitable processing.

FIG. 1 shows an example system 101 that could be used to implement examples of the disclosure. The example system 101 provides a communication setting.

The system 101 shown in FIG. 1 can be used for audio communications. The audio communications can comprise voice communications. Audio from a near end user can be detected, processed and transmitted for rendering and playback to a far end user. In some examples, the audio from a near-end user can be stored in an audio file for later use. Examples of the disclosure could also be used in other systems and/or variations of this system 101.

The system 101 comprises a first user device 103A and a second user device 103B. In the example shown in FIG. 1 each of the first user device 103A and the second user device 103B comprise mobile telephones. Other types of user devices 103 could be used in other examples of the disclosure. For example, the user devices 103 could be a telephone, a tablet, a soundbar, a microphone array, a camera, a computing device, a teleconferencing device, a television, a Virtual Reality (VR)/Augmented Reality (AR) device or any other suitable type of communications device.

The user devices 103A, 103B comprise one or more microphones 105A, 105B and one or more loudspeakers 107A, 107B. The one or more microphones 105A, 105B are configured to detect acoustic signals and convert acoustic signals into output electrical audio signals. The output signals from the microphones 105A, 105B can provide a microphone signal. The one or more loudspeakers 107A, 107B are configured to convert an input electrical signal to an output acoustic signal that a user can hear.

The user devices 103A, 103B can also be coupled to one or more peripheral playback devices 109A, 109B. The playback devices 109A, 109B could be headphones, loudspeaker set ups or any other suitable type of playback devices 109A, 109B. The playback devices 109A, 109B can be configured to enable spatial audio, or any other suitable type of audio to be played back for a user to hear. In examples where the user devices 103A, 103B are coupled to the playback devices 109A, 109B the microphone signals can be processed and provided to the playback devices 109A, 109B instead of to the loudspeaker 107A, 107B of the user device 103A, 103B.

The user devices 103A, 103B also comprise audio processing means 111A, 111B. The processing means 111A, 111B can comprise any means suitable for processing microphone signals from the microphones 105A, 105B and/or processing means 111A, 111B configured for processing audio signals that are provided to the loudspeakers 107A, 107B and/or playback devices 109A, 109B. The processing means 111A, 111B could comprise one or more apparatus 1301 as shown in FIG. 13 and described below and/or any other suitable means.

The processing means 111A, 111B can be configured to perform any suitable processing on the microphone signals and/or any other suitable signals. For example, the processing means 111A, 111B can be configured to perform noise suppression, acoustic echo cancellation, residual echo suppression, speech enhancement, speech dereverberation, wind noise reduction, sound source separation and/or any other suitable process on the microphone signals and/or any other suitable signals. The processing means 111A, 111B can be configured to perform spatial rendering and dynamic range compression on input electrical signals for the loudspeakers 107A, 107B and/or playback devices 109A, 109B. The processing means 111A, 111B can be configured to perform other processes such as active gain control, source tracking, head tracking, audio focusing, or any other suitable process.

The processing means 111A, 111B can be configured to use computer programs such as machine learning programs to process the microphones signals. The machine learning programs can be configured as described or in any other suitable manner.

The processed audio signals can be transmitted between the user devices 103A, 103B using any suitable communication networks. In some examples the communication networks can comprise 4G or 5G or other suitable types of networks. The communication networks can comprise one or more codecs 113A, 113B which can be configured to encode and decode the audio signals as appropriate. In some examples the codecs 113A, 113B could be IVAS (Immersive Voice Audio Systems) codecs or any other suitable types of codec.

In systems such as the system 101 of FIG. 1, noise suppression can be applied by considering signals from multiple microphones. This can be referred to as multi-channel noise suppression.

FIG. 2 shows an example digital signal process (DSP) chain 201 that can be used for multi-channel noise suppression. The DSP chain 201 comprises multiple audio signal processes. The multiple audio signal processes can be applied to signals from multiple microphones 105. In the example of FIG. 2 three microphones 105_1, 105_2, 105_3 are used. Other numbers of microphones 105 could be used in other examples.

The microphones 105_1, 105_2, 105_3 are configured to capture multiple audio signals. Each of the respective audio signals can comprise a speech component (sₓ(t), x=1, 2, 3) and a noise component (nₓ(t), x=1, 2, 3). The speech component sₓ(t) can originate from a person 203 talking. The person 203 could be participating in a communication session such as a teleconference. More than one person could also be participating in the communication session. The noise component nₓ(t) can comprise any unwanted sounds. In the example of FIG. 2 the unwanted sounds comprise traffic noise 205, music 207, babble from other people 209. Other types of wanted sounds and unwanted sounds can be used in other examples.

The respective microphone signals sₓ(t)+nₓ(t) are provided as inputs to respective Short Time Fourier Transform (STFT) transforms 211_1, 211_2, 211_3. The STFT transforms 211_1, 211_2, 211_3 are configured to convert the microphone signals sₓ(t)+nₓ(t) to the STFT domain. The STFT transforms 211_1, 211_2, 211_3 provide transformed microphone signals Eₓ(f) as outputs. Other suitable transforms or filter banks can be used to convert signals into frequency domain representation.

The transformed microphone signals Eₓ(f) are provided as inputs to a first audio signal process. In this example the first audio signal process comprises a beamforming process 213. The beamforming process 213 is configured to combine the transformed microphone signals Eₓ(f) into a single signal. The beamforming process 213 can comprise a minimum variance distortion less response (MVDR) beamformer or any other suitable type of beamformer.

The beamforming process 213 provides a single beamformed signal E(f) as an output. The single output E(f) of the beamforming process 213, or other first audio signal process, is based on the multiple microphone inputs.

The output E(f) of the first audio signal process is provided as an input to a second audio signal process. The second audio signal process can comprise a spectral noise suppression process 215 or any other suitable type of audio signal process.

The spectral noise suppression process 215 comprises an elementwise multiplication of the beamformed signal E(f) by a frequency dependent mask M(f). The mask M(f) in a certain frequency bin has a 1-value if the beamformed signal E(f) comprises mostly speech (or other desired sounds). The mask M(f) in a certain frequency bin has a 0-value if the beamformed signal E(f) comprises mostly noise (or other unwanted sounds). If the beamformed signal E(f) comprises both noise and speech in a frequency bin then a mask value between 0 and 1 is used.

The spectral noise suppression process 215 provides a noise reduced signal \tilde{S}(f) as an output. The noise reduced signal is given by:

\tilde{S}(f)=M(f)E(f)

The noise reduced signal \tilde{S}(f) is provided as an input to an inverse STFT 217. The inverse STFT 217 is configured to convert the noise reduced signal \tilde{S}(f) back to the time domain. The inverse STFT 217 provides the time domain noise reduced signal \tilde{s}(t) as an output.

The example DSP chain 201 of FIG. 2 enables signals from multiple microphones 105 to be combined by the beamforming process 213 to suppress noise with minimal speech distortion. The use of the spectral noise suppression process 215 in addition to the beamforming process 213 can provide for even better noise suppression.

The mask M(f) that is used in the spectral noise suppression process 215 can be generated using any suitable means such as machine learning programs. Masks can also be used for the beamforming process 213. This can require multiple masks to be generated for a single DSP chain 201. This can require a complex machine learning program.

Examples of the disclosure address these issues and provide efficient methods for implementing computer programs such as machine learning programs in audio DSP chains that can be used for noise suppression processing or other types of processing.

FIG. 3 shows an example method that can be implemented in examples of the disclosure. The method could be implemented by an apparatus 1301 as shown in FIG. 13. The apparatus 1301 could be provided in a client device 103 as shown in FIG. 1 or in any other suitable type of device. The apparatus 1301 or client device 103 can be for use in an audio communication setting. The audio communication setting can be a one-way communication setting or a two-way communication setting. The client device 103 could be an electronic device such as a telephone, a camera, a computing device, a teleconferencing device, a television, a virtual reality device, an augmented reality device, and/or any other suitable type of device.

The method comprises, at block 301, obtaining at least one audio signal for a current frame or one or more previous frames. The obtained at least one audio signal is based on at least two microphone signals for the current frame or one or more previous frames. The audio signal can be based on two or more microphone signals and some processing that can be performed on two or more microphone signals so as to provide the at least one audio signal. The at least two microphone signals can be combined so that they are provided as a single input. The microphone signals can be combined using a beamforming process 213 or any other suitable type of process.

In some examples the at least one audio signal comprises an output of a first audio signal process. The first audio signal process can comprise a beamforming process 213 or any other suitable type of process.

At block 303 the method comprises using a program code to predict an output signal for a future frame. The predicted output signal is based, at least in part, on the at least one audio signal for the current frame or one or more previous frames. The future frame is a frame that occurs later than the frames for which the audio signal has been obtained.

The program code can comprise a machine learning program such as a neural network circuit. The neural network circuit could be a deep neural network (DNN) or could have any other suitable type of architecture.

At block 305 the method comprises using the output signal for processing the future frame of the at least two microphone signals in a first audio signal process and also using the output signal for processing the future frame of an output of the first audio signal process in a second audio signal process. The processing of the future frame of an output of the first audio signal process in a second audio signal process enables noise suppression. The same output signal is applied to future frames of multiple audio signal processes.

The first audio signal process and the second audio signal process can be consecutive processes in which the output of the first audio signal process is provided as an input to the second audio signal process. The first audio signal process and the second audio signal process can be part of a DSP chain 201 as shown in FIG. 4 or could be in any other suitable configuration.

The first audio signal process can comprise a beamforming process 213. The beamforming process 213 can be configured to combine multiple microphone signals into a combined microphone signal. The beamforming process 213 can comprise processing the future frame of the at least two microphone signals using the output signal from the program code. In such examples the output signal can comprise a gain to be applied to at least one of the at least two microphone signals of the beamforming process 213. The gain can be a multiplier that is applied to the two or more microphone signals. In some examples the output signal can comprise an amplitude to be used for at least one of the at least two microphone signals of the beamforming process 213. For instance, the amplitude or the multiplication with the gain can be used to compute the complex power spectral density per microphone signal. The amplitudes or the multiplication with the gains for all microphones can be used to compute the complex power spectral density matrices of the noises, speech, or interfering signals. These matrices can be used for obtaining a good configuration of the beamforming process.

The second audio signal process can comprise a spectral noise suppression process 215. The spectral noise suppression process 215 can be configured to further reduce noise in the beamformed microphone signal. In such examples the output signal from the program code can comprise a gain to be applied to the input of the spectral noise suppression process 215. The gain can comprise a multiplier that can be applied to a beamformed microphone signal to obtain a denoised version of the beamformed microphone signal. In some examples the output signal of the program code can comprise an amplitude to be used for the spectral noise suppression process. The amplitude can correspond to the amplitude of the denoised signal to which a prediction of the phase is added to obtain the denoised signal. A prediction of the phase could be the phase of the input signal of the spectral noise suppression process 215.

In some examples the output signal can be applied to the future frame of the respective audio signal processes in a frequency domain. Any suitable transforms can be used to convert the microphone signals to a frequency domain and to convert the processed signals back to the time domain. The output signal from the computer program can be provided in a format that enables it to be used in the respective audio signal processes in the frequency domain.

In some examples the program code receives a single input and provides a single output. This can reduce the complexity of the program code. The single input can comprise any number of features. The single input is single in that it is derived from a single audio signal, for example a beamformed microphone signal. The single output of the program code can be provided in a format that enables it to be applied to the signals in a DSP chain 210. The single output can be applied to multiple audio signal processes.

The number of current or previous frames in the obtained audio signal that are used to predict the output signal for a future frame can be selected based, at least in part, on latency requirements.

FIG. 4 schematically shows a DSP chain 201 that can be used in examples of the disclosure. In this example a program code 401 is used to predict an output signal for both a first audio signal process and a second audio signals process. The program code 401 uses an input signal based on one or more current or previous frames to predict the output signal. The output signal can then be applied to future frames of the respective audio signal processes. The example DSP 201 could be used in a communication setting and/or any other suitable type of setting.

In the example of FIG. 4 The DSP chain 201 comprises three microphones 105_1, 105_2. 105_3. Other numbers of microphones 105 could be used in other examples.

The microphones 105_1, 105_2, 105_3 are configured to capture multiple copies of an audio signal. Each of the respective copies of the audio signal comprise a speech component (sₓ(t), x=1, 2, 3) and a noise component (nₓ(t), x=1, 2, 3). The speech component (sₓ(t), x=1, 2, 3) can comprise the wanted sounds, for example one or more persons talking, that are to be retained in the processed audio signals. The noise component (nₓ(t), x=1, 2, 3) can comprise the unwanted sounds, for example babble noise or traffic noise or a non-targeted person, that are to be suppressed in the processed audio signals.

The respective microphone signals sₓ(t)+nₓ(t) are provided as inputs to respective Short Time Fourier Transform (STFT) transforms 211_1, 211_2, 211_3. The STFT transforms 211_1, 211_2, 211_3 are configured to convert the microphone signals sₓ(t)+nₓ(t) to the STFT domain. The STFT transforms 211_1, 211_2, 211_3 provide transformed microphone signals E₁(f, τ), E₂(f, τ), E₃(f, τ) as outputs where τ indicates a time frame, and f indicates a frequency bin. Alternatively to STFR, also other suitable transforms or filter banks can be used to convert signals into frequency domain representation.

The transformed multiple microphone signals E₁(f, τ), E₂(f, τ), E₃(f, τ) are provided as inputs to a first audio signal process. In this example the first audio signal process comprises a beamforming process 213. Other types of audio signal process could be used in other examples. The beamforming process 213 is configured to combine the transformed microphone signals E₁(f, τ), E₂ (f, τ), E₃(f, τ) into a single beamformed signal E(f, τ). The beamforming process 213 can comprise a minimum variance distortion less response (MVDR) beamformer, a multi-channel Wiener filter or any other suitable type of beamformer.

The beamformed signal E(f, τ) is provided as an input to a second audio signal process. The beamformed signal E(f, τ) is also provided as an input to the program code 401.

The program code 401 receives the beamformed signal E(f, τ) for a current frame and or one or more previous frames. The program code 401 receives a single audio signal as an input. The single audio signal comprises information derived from a single audio signal. In this example, the single audio signal is the beamformed signal E(f, τ).

In this example the program code 401 comprises a machine learning program. The machine learning program can be a deep neural network (DNN) or any other suitable type of program code 401. Examples of a DNN are shown in FIGS. 8 and 9.

The program code 401 is configured to predict an output signal for a future frame of both the first audio signal process and the second audio signal process. The function of the program code 401 is to compute based on a given input, (for example, E(f, τ)) on frequency bin f and current frame τ the output signal to be applied during future frame τ+T. In examples where the program code 401 comprises a DNN this can be expressed as: M^{τ}(f, τ−T)=DNN E(f, τ−T) or M^{τ+T}(f, τ)=DNN E(f, τ).

The output signal M^{τ}(f, τ−T) indicates the output signal that is predicted by the machine learning program or DNN for future frame τ based on the current frame τ−T or previous frames. So, in FIG. 4, at frame τ the output signal M^{τ}(f, t−T) of the DNN is used that is predicted based, at least in part, on the output of the first audio signal process. In this case the output signal M^{τ}(f, τ−T) for the future frame (τ relative to τ−T) is predicted based at least in part, on the beamformed signal E(f, τ−T). The output signal M^{τ}(f, τ−T) for future frame τ is predicted based on a current frame τ−T and/or one or more previous frames of the output of the first audio signal process.

The dots indicated in the output of the computer program 401 represent the fact that the computer program 401 receives an input signal for a certain current (and previous frames), for example E(f, τ). The computer program 401 can then start computing the corresponding output signal which only has to be ready at some future frame τ+T. However, during the current frame τ, the output signal that is computed for the current frame based on a past frame is applied M^{τ}(f, τ−T).

In the example of FIG. 4 the output signal M^{τ}(f, τ−T) can comprise a mask that is applied to multiple signals. The output signal M^{τ}(f, τ−T) can be used as the microphone dependent, frequency dependent, or time-dependent masks for the first audio signal process and the second audio signal process. The same output signal M^{τ}(f, τ−T) is provided to both the first audio signal process and the second audio signal process.

The output signal M^{τ}(f, τ−T) of the program code 401 can be fed back to first audio process. In the example of FIG. 4 the output signal M^{τ}(f, τ−T) can be fed back to the beamforming process 213. The output signal M^{τ}(f, τ−T) can comprise gains to be applied to a future frame of the input microphone signals E₁(f, τ), E₂(f, τ), E₃(f, τ) of the beamforming process 213. The output signal M^{τ}(f, τ−T) can comprise amplitudes that are to be used for a future frame of at least one of the input microphone signals E₁(f, τ), E₂(f, τ), E₃(f, τ) of the beamforming process 213.

The output signal M^{τ}(f, τ−T) of the program code 401 is also provided as an input to the second audio signal process. In this example the second audio signal process comprises a spectral noise suppression process 215. Other types of audio signal process can be used in other examples. The output signal M^{τ}(f, τ−T) can comprise gains to be applied to a future frame of the beamformed signal E(f, τ) in the spectral noise suppression process 215. The output signal M^{τ}(f, τ−T) can comprise amplitudes that are to be used for a future frame of at least one of the beamformed signal E(f, τ) in the spectral noise suppression process 215. The amplitude or the multiplication with the gain can be used to compute the complex power spectral density per microphone signal. The amplitudes or the multiplication with the gains for all microphones can be used to compute the complex power spectral density matrices of the noises, speech, or interfering signals. These matrices can be used for obtaining a good configuration of the beamforming process.

The spectral noise suppression process 215 can use the output signal M^{τ}(f, τ−T) from the program code 401 to control the reduction of noise in the beamformed signal E(f, τ). The spectral noise suppression process 215 provides a noise reduced signal \tilde{S}(f) as an output. The noise reduced signal \tilde{S}(f) can be obtained by multiplying the beamformed signal E(f, τ) and the output signal M^{τ}(f, τ−T) such that: \tilde{S}(f)=M^{τ}(f, τ−T) E(f, τ).

The noise reduced signal \tilde{S}(f) is converted back to the time domain by an inverse STFT 217. The inverse STFT 217 provides the time domain noise reduced signal \tilde{s}(t) as an output.

In the example of FIG. 4 the notation, M^{τ}(f, τ−T) refers to the fact that the program code 401 predicts the output signal for time frame τ based on inputs available up to time frame τ−T. The benefit of this is that the program code 401 has significantly relaxed latency requirements for the computation of the output signal. FIG. 5 shows how this relaxes the latency requirements.

In examples such as the example of FIG. 4 the program code 401 can be a single-channel noise suppression DNN that predicts an STFT mask for a single input STFT signal. This allows the DNN, or other type of program code 401 to be small and optimized for single channel noise suppression. This can be more efficient to train compared to a multi-channel noise suppression DNN. DNN-based single-channel noise suppression can achieve excellent noise suppression performance. DNN-based single-channel noise suppression can outperform classical signal processing techniques. The computational complexity of a single-channel noise suppression DNN is much lower compared to the computational complexity of a multi-channel noise suppression DNN. The weights of the single noise suppression DNN can be trained (with some loss function) to pursue the following relationships:

○S(f)≈Ŝ(f)=M(f)E(f) and Z(f)≈\hat{Z}(f)=(1−M(f))E(f),

Where S(f) denotes the target speech signal, Ŝ(f) denotes the predicted speech signal, M(f) denotes the spectral mask output of the DNN, E(f) denotes the input signal for the DNN, Z(f) denotes the target noise signal, and \hat{Z}(f) denotes the predicted noise signal.

These relationships imply that the mask output of the DNN is such that it predicts the speech when applied to the microphone STFT signal, and it predicts the noise when the difference of 1 and the mask is applied to the microphone STFT signal. Some DNN training loss functions to achieve this are by considering the following loss functions L₁, L₂, L₃ or L₄, where s(t) denotes the target speech in time domain:

$${L}_{1} = {( M ( f ) - \frac{\vert S ( f ) \vert}{\vert E ( f ) \vert} )}^{2} or$$

$${L}_{2} = {( \vert M ( f ) E ( f ) \vert - \vert S \vert )}^{2} or {L}_{3} = {( {\vert M ( f ) E ( f ) \vert}^{0.3} - {\vert S \vert}^{0.3} )}^{2} or$$

$${L}_{4} = {( ISTFT ( M ( f ) E ( f ) ) - s ( t ) )}^{2}$$

In examples of the disclosure the output of the program code 401 provides a single output signal that can be used for multiple audio signal processes. In the example of FIG. 4 the predicted output signal M^{τ}(f, τ−T) is used as the mask for the spectral postfilter in the spectral noise reduction process 215 and also for the microphone, frequency and time-dependent masks of the beamforming process 213. The reuse of a single output signal M^{τ}(f, τ−T) for multiple audio signal processes enables a very low complexity DNN, or other type of program code 401, to be used.

In the example of FIG. 4, during frame τ, the beamforming process 213 needs to compute the output E(f, τ) from the inputs E₁(f, τ), E₂(f, τ), E₃(f, τ) based on the output signal M^{τ}(f, τ−T). The program code 401 can compute the output signal M^{τ}(f, τ−T) in advance based on inputs that were available at frame τ−T, where T refers to the number of frames of prediction. This gives the program code 401 about T frames of time to compute the output signals M^{τ}(f, τ−T). The examples of the disclosure are not restricted to a single frame ahead prediction. For instance, in some examples four frame ahead prediction could be used. In such examples the output signal can be denoted M^{τ}(f, τ−4) and the program code 401 can use information derived from frame τ−4 and earlier frames to predict the output signal for frame τ.

This relaxes the latency requirements of the program code 401 computation to four frames which could be around 40 ms.

FIG. 5 shows how using different numbers of frames in the frame ahead prediction can affect the latency requirement and the complexity of the program code 401. FIG. 5 shows example computation pipelines for different approaches. The first pipeline 501 is shown for an implementation in which there is no frame ahead prediction. In this pipeline the output of the program code 401 is predicted for the current frame.

The other pipelines 503, 505, 507 are for approaches that make use of examples of the disclosure. The second pipeline 503 uses 1-frame ahead prediction, the third pipeline 505 uses 2-frame ahead prediction, and the fourth pipeline 507 uses 3-frame ahead prediction.

In the example of FIG. 5, for each frame the corresponding signals are communicated to and from the program code 401 as indicated by the arrows. The signals communicated to the program code 401 can comprise STFT signals. The signals communicated to the program code 401 can be based on microphone signals. Some processing can be performed on the microphone signals before they are communicated to the program code 401 The signals communicated to the program code 401 can comprise beamformed signals E(f, τ) or any other suitable type of signal.

The signals communicated from the program code 401 can also comprise STFT signals or a compressed version thereof (e.g. Mel-frequency cepstral coefficients, equivalent rectangular bandwidth (ERB) coefficients or Bark scale coefficients). The signals communicated from the program code 401 can comprise an output signal M^{τ}(f, τ−T). The output signal M^{τ}(f, τ−T) can comprise STFT masks or a compressed version thereof (e.g. in ERB or Bark scale).

The program code 401 has a time interval to perform the inferences so as to obtain the predicted output signal M^{τ}(f, τ−T). The time interval is dependent upon the number of future frame predictions and also the time needed for transferring the input and output signals to and from the program code, respectively. The time intervals available for the program code 401 to perform the inferences is indicated by the horizontal width of the boxes in the respective pipelines in FIG. 5. The time intervals available for the transfer of the input and output signals to and from the program code are indicated by the horizontal length of the arrows 515 in the respective pipelines in FIG. 5.

The first pipeline 501 corresponds to an example that does not use any future frame predictions. In this example the program code 401 that is used to predict the masks or other output signals comprises multiple single-channel DNNs each processing one of the microphone signals in parallel. The multiple single-channel DNNs are indicated by the dots in FIG. 5. In this pipeline 501 the program code 401 has much less than a full frame of time to compute the output signal.

The second pipeline 503 shows an example of the disclosure in which the program code 401 comprises a single-channel DNN using a 1-frame ahead prediction. The microphone signals are combined into a single audio signal and provided as an audio input signal to the program code 401. For example, the microphone signals can be combined by a beamforming process 213. Only one single-channel DNN is used in the second pipeline 503 because only one audio signal input is used. This reduces the complexity of the program code 401 compared to that used in the first pipeline 501.

In this second pipeline 503 the input at frame t−3 is communicated to the sole single-channel DNN to infer the mask for frame t−2. The program code 401 has about a full frame of time to compute the output signal. The latencies indicated by the horizontal length of the arrows 515 are allowed to be larger in the second pipeline 503 because there is a full frame of time available for transferring the input and output signals and the DNN inference, and the latencies are thus relaxed.

The single-channel DNN that is used in the second pipeline 503 can have the same architecture as the single-channel DNN that is used in the first pipeline 501 however different weights would be used. The respective single-channel DNNs would have the same number of computations. The computations can be Multiply Accumulate (MAC) computations, non-linear activation functions or any other suitable type of computations.

FIG. 5 shows that the program code 401 in the second pipeline 503 has substantially relaxed latency and computational complexity requirements compared to the first pipeline 501 that does not use any future frame predictions. This is indicated by the significant increase in the width of the boxes in the second pipeline 503 compared to the first pipeline 501. The latencies indicated by the horizontal length of the arrows 515 are allowed to be larger in the third pipeline 505 because there are two full frames of time available for transferring the input and output signals and the DNN inference. The same amount of input and output data is transferred in a larger time and so this provides significantly relaxed latency requirements.

The third pipeline 505 shows an example of the disclosure in which the program code 401 comprises a single-channel DNN using a 2-frame ahead prediction. In this example the input at frame t−3 is communicated to the program code 401 to infer the output signal for frame t−1. The program code 401 has about two full frames of time to compute the output signal. In the third pipeline 505, the program code 401 comprises two single-channel DNNs deployed in parallel. The first single-channel DNN is indicated by the first row of boxes 509 and the second single-channel DNN is indicated by the second row of boxes 511. The use of two single-channel DNNs in parallel increases the complexity of the program code 401 compared to the program code 401 used in the second pipeline 503 however, the time available to perform the computations has approximately doubled compared to the time available in the second pipeline 503. The latencies indicated by the horizontal length of the arrows 515 are allowed to be even larger in the fourth pipeline 507 because there are three full frames of time available for transferring the input and output signals and the DNN inference. The same amount of input and output data is transferred in a larger time and so this provides even further relaxed latency requirements.

The fourth pipeline 507 shows another example of the disclosure in which program code 401 comprises a single-channel DNN using a 3-frame ahead prediction. In this example the input at frame t−3 is communicated to the program code 401 to infer the mask for frame t. The program code 401 has about three full frames of time to compute the output signal. For this version, the program code 401 comprises three single-channel DNNs deployed in parallel. The first single-channel DNN is indicated by the first row of boxes 509, the second single-channel DNN is indicated by the second row of boxes 511 and the third single-channel DNN is indicated by the third row of boxes 513. The use of three single-channel DNNs in parallel increases the complexity of the program code 401 compared to the program code 401 used in the second pipeline 503 and the third pipeline 505 however, the time available to perform the computations has approximately tripled compared to the time available in the second pipeline 503. The latencies indicated by the horizontal length of the arrows 515 are allowed to be larger compared to that of the first, second and third pipelines 501, 503, 505.

In examples of the disclosure the program code 401 can be configured to predict any suitable number of frames ahead. When determining the number of the frames ahead to use for the prediction the performance of the audio signal processing is taken into account. The further ahead the output is predicted for the more difficult it is to predict the output signal. The size of the frames is also taken into account. If the frames have smaller sizes, then a larger frame-ahead value can be used. Increasing the frame-ahead value provides more relaxed latency requirements because this gives more time before the output signal needs to be ready. Therefore, determining the frame-ahead value is a trade-off between latency and prediction accuracy.

FIG. 6 schematically shows a system 601 that can be used to implement some examples of the disclosure. The system 601 shown in FIG. 6 could be implemented in a user device 103 as shown in FIG. 1 and/or could be implemented in any other suitable type of device or combinations of devices.

The system 601 comprises multiple microphones 105. In FIG. 6 three microphones are shown. Other numbers of microphones 105 could be used in other examples.

The microphones 105 provide multiple microphone input signals 603. Each of the multiple microphones 105 provides a respective microphone input signal 603. In the example of FIG. 6 there are three microphones 105 and so three microphone input signals 603 are provided. Other numbers of microphone input signals 603 could be used in other examples.

The microphone input signals 603 are provided as inputs to a central processing unit (CPU) 605 or a DSP system. The CPU 605 is configured to implement a first audio signal process and a second audio signal process. The first audio signal process and the second audio signal process can be performed on two or more of the microphone input signals 603. The first audio signal process and the second audio signal process can be consecutive processes so that the output of the first audio signal process is provided as an input the second audio signal process.

The first audio signal process can comprise a beamforming process 213 and the second audio signal process can comprise a spectral noise reduction process 215 or any other suitable type of process. The beamforming process 213 and the spectral noise reduction process 215 can be as shown in FIG. 4. Other types of audio signal processes can be used in other examples.

The respective audio signal processes that are performed by the CPU 605 can be based on masks or other output signals that are output from a program code 401.

The masks or output signals that are used for the audio signal processes performed by the CPU 605 are obtained from the DNN engine 609. The DNN engine comprises program code 401 that is configured to predict an output signal for a future frame based on an audio signal for a current frame or one or more previous frames.

The CPU 605 provides an audio signal 607 to the DNN engine 609. The audio signal 607 is based on at least two microphone signals 603. The audio signal 607 can comprise a combined microphone signal, or features extracted from a combined microphone signal, and/or any other suitable input. The combined microphone signal can be obtained by performing beamforming, or any other suitable process, on two or more of the microphone signals 603.

The audio signal 607 that is provided to the DNN engine 609 comprises a current frame and/or one or more previous frames. A single audio signal 607 can be provided from the CPU to the DNN engine 609.

The DNN engine 609 can comprise a software routine in a DSP or Graphical Processing Unit (GPU), or can be a Hardware accelerator or any other suitable means.

The DNN engine 609 comprises program code 401 configured to process the audio signal 607 to generate an output signal 611. The program code 401 can comprise one or more single-channel DNNs or any other suitable type of program code 401. The number of single-channel DNNs that are comprised in the program code 401 can be determined by the number of frames ahead for which the prediction is made, and/or any other suitable factor. For instance, if one frame ahead prediction is used then the program code 401 can comprise only one single-channel DNN. If two frame ahead prediction is used then the program code 401 can comprise two single-channel DNNs.

The output signal 611 provided by the DNN engine 609 can comprise masks that can be used for the respective audio signal processes of the CPU 605. The masks are predicted from previous frames but can be used for current frames. The same output signal can be used for future frames of both the first audio signal process and the second audio signal process. The output signal 611 can comprises masks, gains, amplitudes, and/or any other suitable information for use in the first audio signal process and the second audio signal process.

The CPU 605 uses the output signal 611 in both the first audio signal process and the second audio signal process. The CPU 605 provides a processed signal 613 as an output. In this example the processed signal 613 is a noise suppressed signal. Other types of processing can be performed in other examples.

FIG. 7 shows an example method that can be used in some examples of the disclosure.

At block 701 the method comprises obtaining a current frame or one or more previous frames of an audio signal. The audio signal can be based on microphone signals. The audio signal can comprise a combined microphone signal.

The audio signal comprising the current frame or one or more previous frames that is obtained can comprise the output of a first audio signal process. The first audio signal process can be performed on two or more input microphone signals. The first audio signal process can comprise a beamforming process 213 or any other suitable process.

The first audio signal process can be part of a DSP chain 201. The DSP chain 201 could comprise at least the first audio signal process and a second audio signal process. The first audio signal process and the second audio signal process could be consecutive processes in which the output of the first audio signal process is provided as an input to the second audio signal process. The first audio signal process can comprise a beamforming process 213 and the second audio signal process can comprise a spectral noise reduction process 215. The DSP chain 201 could be as shown in FIG. 4 or could be any other suitable DSP chain 201.

At block 703 features are extracted from the audio signal and provided as an input to the program code 401. The features can be extracted from the audio signal so as to provide an input in a suitable format for the program code 401. This could comprise a compression of the dimension of the audio signal by extracting the Mel-frequency cepstral coefficients, equivalent rectangular bandwidth (ERB) grid coefficients or Bark scale grid coefficients. This could also comprise normalizing or standardizing the audio signal by subtracting an online computed average or by dividing by an online computed standard deviation. This could also comprise a logarithm power conversion of the audio signals.

At block 705 the program code 401 uses the features extracted from the audio signal to predict an output signal. The output signal can comprise a mask, or any other suitable information, that can be used for future frames of at least two audio signal processes in the DSP chain 201. The audio signal processes can comprise a beamforming process 213 and a spectral noise reduction process 215 and/or any other suitable audio signal processes.

The program code 401 can comprise a DNN as shown in FIGS. 8 and/or 9 or any other suitable type of program code.

At block 707 the output signal is communicated from the program code 401 to the DSP chain 201. At block 709 the output signal is applied to the future frame for both the first audio signal process and the second audio signal process for a future frame. In examples of the disclosure the program code 401 provides a single output signal. The same output signal is used for a future frame for both the first audio signal process and the second audio signal process. The output signal can be used as masks in the respective processes. The masks can be microphone dependent, frequency dependent, time dependent or have any other suitable configuration.

At block 711 a processed signal is output by the DSP chain 201. In this example the processed signal can comprise a noise reduced signal. Other types of processed signal can be provided in other examples.

In some examples the program code 401 can comprise a machine learning program, FIG. 8 shows an example machine learning program that can be used in some examples of the disclosure. In this example the machine learning program comprises a Deep Neural network (DNN) 801. The DNN 801 comprises an input layer 803, an output layer 807, and a plurality of hidden layers 805. The hidden layers 805 are provided between the input layer 803 and the output layer 807. The example DNN 801 shown in FIG. 8 comprises two hidden layers 805 but the DNN 801 could comprise any number of hidden layers 805 in other examples.

Each of the layers within the DNN 801 comprises a plurality of nodes 809. The nodes 809 within the respective layers are connected together by a plurality of connections 811, or edges, as shown in FIG. 8. Each connection 811 represents a multiplication with a weight configuration. Within the nodes 809 of the hidden layers 805 and output layers 807 a nonlinear activation function is applied to obtain a multi-dimensional nonlinear mapping between the inputs and the outputs.

In examples of the disclosure the DNN 801 is trained or configured to map a single input signal to a corresponding output signal. The input signals can comprise any suitable inputs such as the output of a beamforming process 213 or any other inputs based on microphone signal. The output signal can comprise a mask, or any other suitable information for use in the beamforming process 213 and a spectral noise suppression process 215 and/or any other suitable process.

FIG. 9 shows an example architecture for a machine learning program that can be used as the program code 401 in some examples of the disclosure.

In this example the program code 401 comprises a DNN. The architecture in FIG. 9 comprises a multi-layer interconnected residual gated recurrent unit (GRU) network. Other architectures for the program code 401 could be used in other implementations of the disclosure.

The program code 401 receives a single input 901. The input 901 comprises an audio signal. The input 901 is a single input in that it comprises information derived from a single signal. The single signal can be based on two or more microphone signals. For example, the single signal could be the output of a beamforming process 213 or other type of process that combines multiple microphone signals.

The input 901 can be provided in any suitable format. For example, the input 901 can be provided in STFT format. The input 901 can be provided as the logarithm powers of an STFT frame. In some examples the input 901 can also be prepended by an STFT to ERB (Equivalent rectangular Bandwidth) grid conversion or a STFT to Bark scale grid conversion or a STFT to Mel-frequency cepstral coefficients conversion to reduce the complexity of the program code 401.

The input 901 is provided to a series of four consecutive gated recurrent unit (GRU) layers 903, 905, 907, 909. Each of the respective GRU layers 903, 905, 907, 909 has a residual skip connection 917, 919, 921, 923. For each of the respective GRU layers 903, 905, 907, 909 the input is also added to the output.

The outputs of each of the GRU layers 903, 905, 907, 909 are provided as inputs to a linear end layer 911. The linear end layer 911 combines the respective inputs.

The output of the linear end layer 911 is provided as input to a sigmoid activation function 913 to generate the output 915 of the program code 401. The program code 401 provides a single output 915. The single output 915 can be provided in any suitable format. The single output can have a dimension that enables it to be applied to a signal with similar dimensions. For instance, the output 915 can be in an STFT format so that the output 915 can be applied to other STFT signals. The output 915 is a single signal but it can be applied to multiple audio processes, for example a beamforming process 213 and a spectral noise suppression process 915.

In this example the output signal 915 comprises a mask that can be used for the first audio signal process and the second audio signal process. The mask can be used for future frames of the respective audio signal processes.

Any suitable process can be used to train the program code 401. An example training objective or loss function that can be used to train such a program code 401 could be as follows:

$${( {M}^{τ} ( f , τ - T ) - \frac{\vert S ( f , τ ) \vert}{\vert E ( f , τ ) \vert} )}^{2}$$

where T refers to the number of frames that the program code 401 needs to predict ahead of time.

Another example training objective or loss function that can be used to train such a program code 401 could be as follows:

$${( {M}^{τ + T} ( f , τ ) - \frac{\vert S ( f , τ + T ) \vert}{\vert E ( f , τ + T ) \vert} )}^{2}$$

FIG. 10 shows an example room 1001 and microphone array 1003 that were used with examples of the disclosure to obtain the example results shown in FIGS. 11 and 12. The room 1001 has dimensions 5 m (x-axis)×5 m (y-axis)×3 m (height).

The microphone array 1003 comprises a linear array of four microphones. The respective microphones are spaced at 10 cm intervals within the linear array.

FIG. 10 shows four signals 1005A-D. The first signal 1005A is the speech signal. The other signals 1005B-D are the noise signals. In the example the second signal 1005B comprises babble noise and the third signal 1005C and fourth signal 1005D are white noise signals.

To obtain the example results shown in FIGS. 11 and 12 STFT domain processing with a Hann window, and a frame and hop size of 1024 and 512 samples, respectively was used. This corresponds to frames of about 20 ms, when considering a 48 kHz sample frequency. Examples of the disclosure were applied with 1-frame ahead prediction.

Using 1-frame ahead prediction relaxes the latency requirements to less than 15-20 ms, instead of less than 5 ms.

FIG. 11 shows a plot of example results in linear scale and FIG. 12 shows a plot of example results in dB scale. The first plot 1101 in FIG. 11 and the first plot 1201 in FIG. 12 show the captured signal on a first microphone 105. This indicates that there is a significant amount of noise within the signal. The second plot 1103 in FIG. 11 and the second plot 1203 in FIG. 12 show the signal after the beamformer process 213 and spectral noise suppression process 215 using examples of the disclosure. These show that the noise is significantly reduced without too much speech distortion.

The prediction of the output signals for the future frames of the respective audio signal processes provides benefits for the program codes 401 used to make the predictions. As described herein the prediction for future frames can relax the latency requirements and also reduce the complexity if the program codes 401 that are needed.

FIG. 13 schematically illustrates an apparatus 1301 that can be used to implement examples of the disclosure. In this example the apparatus 1301 comprises a controller 1303. The controller 1303 can be a chip or a chip-set. In some examples the controller can be provided within a user device 103 such as the user devices 103 shown in FIG. 1.

In the example of FIG. 13 the implementation of the controller 1303 can be as controller circuitry. In some examples the controller 1303 can be implemented in hardware alone, have certain aspects in software including firmware alone or can be a combination of hardware and software (including firmware).

As illustrated in FIG. 13 the controller 1303 can be implemented using instructions that enable hardware functionality, for example, by using executable instructions of a computer program 1309 in a general-purpose or special-purpose processor 1305 that can be stored on a computer readable storage medium (disk, memory etc.) to be executed by such a processor 1305.

The processor 1305 is configured to read from and write to the memory 1307. The processor 1305 can also comprise an output interface via which data and/or commands are output by the processor 1305 and an input interface via which data and/or commands are input to the processor 1305.

The memory 1307 is configured to store a computer program 1309 comprising computer program instructions (computer program code 401) that controls the operation of the controller 1303 when loaded into the processor 1305. The computer program instructions, of the computer program 1309, provide the logic and routines that enables the controller 1303 to perform the methods illustrated in the Figs. The processor 1305 by reading the memory 1307 is able to load and execute the computer program 1309.

The apparatus 1301 therefore comprises: at least one processor 1305; and at least one memory 1307 including computer program code 401, the at least one memory 1307 and the computer program code 401 configured to, with the at least one processor 1305, cause the apparatus 1301 at least to perform:
obtaining 301 at least one audio signal for a current frame or one or more previous frames, based on at least two microphone signals for the current frame or one or more previous frames;
using a program code 401 to predict 303 an output signal for a future frame based, at least in part, on the at least one audio signal for the current frame or one or more previous frames; and
using 305 the output signal for processing the future frame of the at least two microphone signals in a first audio signal process and using the output signal for processing the future frame of an output of the first audio signal process in a second audio signal process to enable noise suppression.

As illustrated in FIG. 13 the computer program 1309 can arrive at the controller 1303 via any suitable delivery mechanism 1311. The delivery mechanism 1311 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1309. The delivery mechanism can be a signal configured to reliably transfer the computer program 1309. The controller 1303 can propagate or transmit the computer program 1309 as a computer data signal. In some examples the computer program 1309 can be transmitted to the controller 1303 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 1309 comprises computer program instructions that when executed by an apparatus 1301 cause the apparatus 1301 to perform at least the following:
obtaining 301 at least one audio signal for a current frame or one or more previous frames, based on at least two microphone signals for the current frame or one or more previous frames;
using a program code 401 to predict 303 an output signal for a future frame based, at least in part, on the at least one audio signal for the current frame or one or more previous frames; and
using 305 the output signal for processing the future frame of the at least two microphone signals in a first audio signal process and using the output signal for processing the future frame of an output of the first audio signal process in a second audio signal process to enable noise suppression.

The computer program instructions can be comprised in a computer program 1309, a non-transitory computer readable medium, a computer program product, a machine readable medium. In some but not necessarily all examples, the computer program instructions can be distributed over more than one computer program 1309.

Although the memory 1307 is illustrated as a single component/circuitry it can be implemented as one or more separate components/circuitry some or all of which can be integrated/removable and/or can provide permanent/semi-permanent/dynamic/cached storage.

Although the processor 1305 is illustrated as a single component/circuitry it can be implemented as one or more separate components/circuitry some or all of which can be integrated/removable. The processor 1305 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software can not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The apparatus 1301 as shown in FIG. 13 can be provided within any suitable device. In some examples the apparatus 1301 can be provided within an electronic device such as a mobile telephone, a teleconferencing device, a camera, a computing device or any other suitable device.

The blocks illustrated in the Figs. can represent steps in a method and/or sections of code in the computer program 1309. The illustration of a particular order to the blocks does not necessarily imply that there is a required or preferred order for the blocks and the order and arrangement of the blocks can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus for noise suppression comprises: at least one processor; and at least one memory including computer program code, the at least one memory and the computer program code configured to, with the at least one processor, cause the apparatus at least to:
obtain at least one audio signal for a current frame or one or more previous frames, based on at least two microphone signals for the current frame or one or more previous frames;
use a program code to predict an output signal for a future frame based, at least in part, on the at least one audio signal for the current frame or one or more previous frames; and
use the output signal for processing the future frame of the at least two microphone signals in a first audio signal process and using the output signal for processing the future frame of an output of the first audio signal process in a second audio signal process to enable noise suppression.

2. An apparatus as claimed in claim 1, wherein the at least one audio signal comprises an output of the first audio signal process.

3. An apparatus as claimed in claim 1, wherein the first audio signal process and the second audio signal process are consecutive processes in which the output of the first audio signal process is provided as an input to the second audio signal process.

4. An apparatus as claimed in claim 1, wherein the first audio signal process comprises a beamforming process, and wherein the beamforming process comprises processing the future frame of the at least two microphone signals using the output signal.

5. An apparatus as claimed in claim 4, wherein the output signal comprises a gain to be applied to at least one of the at least two microphone signals of the beamforming process.

6. An apparatus as claimed in claim 4, wherein the output signal comprises an amplitude to be used for at least one of the at least two microphone signals of the beamforming process.

7. An apparatus as claimed in claim 1, wherein the second audio signal process comprises a spectral noise suppression process.

8. An apparatus as claimed in claim 7, wherein the output signal comprises a gain to be applied to the input of the spectral noise suppression process.

9. An apparatus as claimed in claim 7, wherein the output signal comprises an amplitude to be used for the spectral noise suppression process.

10. An apparatus as claimed in claim 1, wherein the output signal is applied to the future frame of the respective audio signal processes in a frequency domain.

11. An apparatus as claimed in claim 1, wherein the program code receives a single input and provides a single output.

12. An apparatus as claimed in claim 1, wherein the program code comprises a machine learning program.

13. An apparatus as claimed in claim 12 wherein the machine learning program comprises a neural network circuit.

14. An apparatus as claimed in claim 1, wherein the same output signal is applied to future frames of multiple audio signal processes.

15. An apparatus as claimed in claim 1, wherein the number of current or previous frames in the obtained audio signal that are used to predict the output signal for a future frame are selected based, at least in part, on latency requirements.

16. An apparatus as claimed in claim 1, wherein the apparatus is for use in an audio communication setting.

17. An apparatus as claimed in claim 16, wherein the audio communication setting is at least one of;
a one-way communication setting; or
a two-way communication setting.

18. An apparatus as claimed in claim 1, wherein the apparatus is at least one of: a telephone; a camera; a computing device; a teleconferencing device; a television; a virtual reality device; or an augmented reality device.

19. A method for noise suppression comprising:
obtaining at least one audio signal for a current frame or one or more previous frames, based on at least two microphone signals for the current frame or one or more previous frames;
using a program code to predict an output signal for a future frame based, at least in part, on the at least one audio signal for the current frame or one or more previous frames; and
using the output signal for processing the future frame of the at least two microphone signals in a first audio signal process and using the output signal for processing the future frame of an output of the first audio signal process in a second audio signal process to enable noise suppression.

20. A non-transitory computer-readable storage medium that comprises a computer program for noise suppression comprising instructions which, when executed by an apparatus, cause the apparatus to perform at least:
obtaining at least one audio signal for a current frame or one or more previous frames, based on at least two microphone signals for the current frame or one or more previous frames;
using a program code to predict an output signal for a future frame based, at least in part, on the at least one audio signal for the current frame or one or more previous frames; and
using the output signal for processing the future frame of the at least two microphone signals in a first audio signal process and using the output signal for processing the future frame of an output of the first audio signal process in a second audio signal process to enable noise suppression.
